(19) United States
(12) Patent Application Publication
(10) Pub. No.: US 2021/0157647 A1
(43) Pub. Date: May 27, 2021

(54) NUMA SYSTEM AND METHOD OF MIGRATING PAGES IN THE SYSTEM

(71) Applicant: Alibaba Group Holding Limited, Georgetown (KY)

(72) Inventors: Shasha WEN, Hangzhou (CN); Pengcheng LI, Hangzhou (CN); Xiaoxin FAN, Hangzhou (CN); Li ZHAO, Hangzhou (CN)

(21) Appl. No.: 16/863,954

(22) Filed: Apr. 30, 2020

Related U.S. Application Data
(60) Provisional application No. 62/939,961, filed on Nov. 25, 2019.

(51) Int. Cl. G06F 9/50; G06F 12/0882; G06F 12/0846; G06F 13/16; G06F 11/07

(52) U.S. Cl. CPC G06F 9/5016; G06F 9/5088; G06F 12/0882; G06F 12/0848; G06F 2209/5022; G06F 11/076; G06F 2212/2542; G06F 2209/508; G06F 13/1684

(57) ABSTRACT

Remote access latency in a non-uniform memory access (NUMA) system is substantially reduced by monitoring which NUMA nodes are accessing which local memories, and migrating memory pages from the local memory in a first NUMA node to the local memory in a hot NUMA node when the hot NUMA node is frequently accessing the local memory in the first NUMA node.

### CROSS-REFERENCE TO RELATED APPLICATIONS

The present application claims priority to U.S. Provisional Patent Application No. 62/939,961, filed Nov. 25, 2019, which application is incorporated herein by reference in its entirety.

### BACKGROUND OF THE INVENTION

### 1. Field of the Invention

The present invention relates to non-uniform memory access (NUMA) system and, more particularly, to a NUMA system and a method of migrating pages in the system.

### 2. Description of the Related Art

A non-uniform memory access (NUMA) system is a multiprocessing system that has a series of NUMA nodes, where each NUMA node has a partition of memory and a number of processors coupled to the partition of memory. In addition, multiple NUMA nodes are coupled together such that each processor in each NUMA node sees all of the memory partitions together as one large memory.

As the name suggests, a NUMA system has non-uniform access times, with local access times to the memory partition of a NUMA node being much shorter than remote access times to the memory partition of another NUMA node. For example, remote access times to the memory partition of another NUMA node can have a 30-40% longer latency than the access times to the local memory partition.

In order to improve system performance, there is a need to reduce the latency associated with the remote access times. To date, existing approaches have had limitations. For example, profiling-based optimizations use aggregated views which, in turn, fail to adapt to varying access patterns. In addition, one needs to recompile the code to use previous profiling information.

As another example, existing dynamic optimizations are often implemented in the kernel which, in turn, requires expensive kernel patches whenever any change is required. As a further example, existing rare user-space tools use page-level information to reduce remote memory access times, but have bad performance for large-size data objects. Thus, there is a need to reduce the latency associated with the remote access times that overcomes these limitations.

### SUMMARY OF THE INVENTION

The present invention reduces the latency associated with remote access time by migrating data between NUMA nodes based on the NUMA node that is accessing the data the most. The present invention includes a method of operating a NUMA system. The method includes determining a requested data object from a requested memory address in a sampled memory request from a requesting NUMA node. The requested data object represents a range of memory addresses. The method also includes determining whether a size of the requested data object is a page or less, or more than a page. When the size of the requested data object is a page or less, the method increments a count that measures a number of times that the requesting NUMA node has sought to access the requested data object. The method further determines whether the count has exceeded a threshold within a predetermined time period, and when the count exceeds the threshold, migrates the page that includes the requested data object to the requesting NUMA node.

The present invention also includes a NUMA system that includes a memory partitioned into a series of local partitions, and a series of NUMA nodes coupled to the local partitions. Each NUMA node has a corresponding local partition of the memory, and a number of processors coupled to the memory. The NUMA system further includes a bus that couples the NUMA nodes together, and a profiler that is coupled to the bus. The profiler to determine a requested data object from a requested memory address in a sampled memory request from a requesting NUMA node. The requested data object represents a range of memory addresses. The profiler to also determine whether a size of the requested data object is a page or less, or more than a page. When the size of the requested data object is a page or less, the profiler to increment a count that measures a number of times that the requesting NUMA node has sought to access the requested data object. The profiler to further determine whether the count has exceeded a threshold within a predetermined time period, and when the count exceeds the threshold, migrate the page that includes the requested data object to the requesting NUMA node.

The present invention further includes a non-transitory computer-readable storage medium that has embedded therein program instructions, which when executed by one or more processors of a device, causes the device to execute a process that operates a NUMA system. The process includes determining a requested data object from a requested memory address in a sampled memory request from a requesting NUMA node. The requested data object represents a range of memory addresses. The process to further include determining whether a size of the requested data object is a page or less, or more than a page. When the size of the requested data object is a page or less, the process to increment a count that measures a number of times that the requesting NUMA node has sought to access the requested data object. The process to additionally determine whether the count has exceeded a threshold within a predetermined time period, and when the count exceeds the threshold, migrate the page that includes the requested data object to the requesting NUMA node.

A better understanding of the features and advantages of the present invention will be obtained by reference to the following detailed description and accompanying drawings which set forth an illustrative embodiment in which the principals of the invention are utilized.

### BRIEF DESCRIPTION OF THE DRAWINGS

The accompanying drawings described herein are used for providing further understanding of the present application and constitute a part of the present application. Exemplary embodiments of the present application and the description thereof are used for explaining the present application and do not constitute limitations on the present application.

FIG. 1 is a block diagram that illustrates an example of a non-uniform memory access (NUMA) system 100 in accordance with the present invention.

FIG. 2 is a flow chart illustrating an example of a method 200 of migrating pages in a NUMA system in accordance with the present invention.

FIG. 3 is a flow chart illustrating an example of a method 300 that profiles a program in accordance with the present invention.

### DETAILED DESCRIPTION OF THE INVENTION

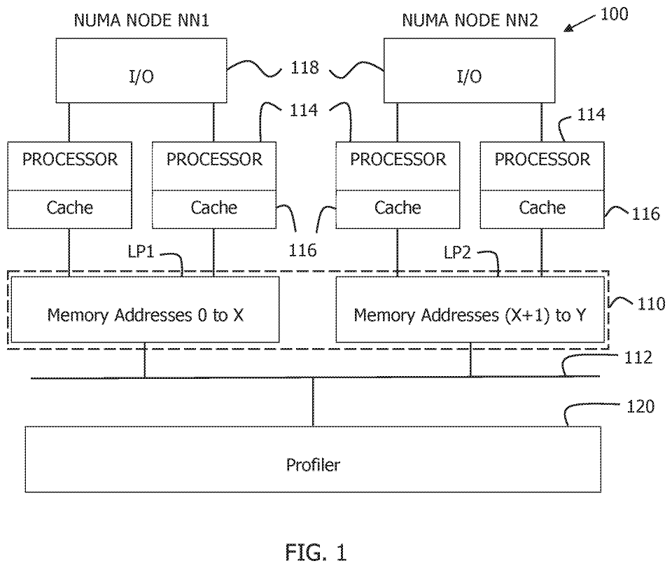

FIG. 1 shows a block diagram that illustrates an example of a non-uniform memory access (NUMA) system 100 in accordance with the present invention. As shown in FIG. 1, NUMA system 100 includes a memory 110, which has been partitioned into a series of local partitions LP1-LPm, a series of NUMA nodes NN1-NNm coupled to the local partitions LP1-LPm, and a bus 112 that couples the NUMA nodes NN1-NNm together. Each NUMA node NN has a corresponding local partition LP of memory 110, a number of processors 114, each with their own local cache 116, coupled to memory 110, and input/output circuitry 118 coupled to the processors 114.

As further shown in FIG. 1, NUMA system 100 includes a profiler 120 that is connected to bus 112. In operation, profiler 120, which can be implemented with a CPU, samples NUMA node traffic on bus 112, records the sampled bus traffic, and migrates a page or more of a data object stored in a first local partition to a second local partition when the sampled bus traffic indicates that the second local partition is accessing the data object more than a threshold amount.

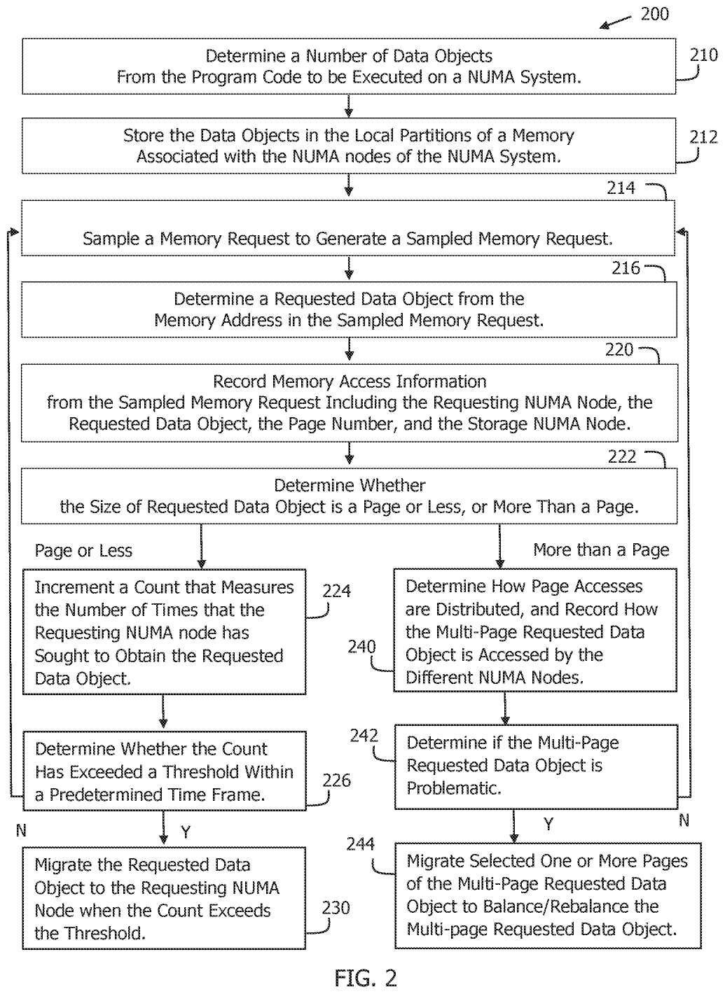

FIG. 2 shows a flow chart that illustrates an example of a method 200 of migrating pages in a non-uniform memory access (NUMA) system in accordance with the present invention. In one embodiment of the present invention, method 200 can be implemented with NUMA system 100. Method 200 records the static mapping of the topology about CPUs and NUMA domain knowledge of the system.

As shown in FIG. 2, method 200 begins at 210 by determining a number of data objects from the code of a program to be executed on the NUMA system. Each data object, in turn, represents a range of related memory addresses. For example, the range can be related by the data stored in the range of memory addresses. Heap data: overload memory allocation and free functions can be used to identify data objects, along with static data: track the load and off-load of each module, and read its symbol table. Data objects can be small, having a range of addresses that occupy a page or less, or large, having a range of addresses that is more than a page.

Method 200 next moves to 212 to store the data objects in the local partitions of a memory associated with the NUMA nodes of the NUMA system. For example, by examining the code of the program to be executed on NUMA system 100, a data object can be stored in the local partition of the NUMA node which has the processor that is the first to access the data object. For example, with reference to FIG. 1, if a processor 114 in NUMA node NN1 is the first to access a data object (via a requested memory address), then method 200 stores the data object in the local partition LP1 of NUMA node NN1.

Following this, during execution of the program on a NUMA system, such as NUMA system 100, method 200 moves to 214 to use performance monitoring to sample a memory access request from a processor in a NUMA node of the NUMA system to generate a sampled memory request. A sampled memory request includes a requested memory address, which can be identified by a block number, a page number in the block, and a line number in the page. The sampled memory request also includes, for example, the requesting NUMA node (the identity of the NUMA node which output the memory access request that was sampled), and the storage NUMA node (the identity of the local partition that stores the requested memory address). In one embodiment, a record can be made of each memory access request made by each processor in each NUMA node. These records can then be sampled to obtain the sampled memory request, as a record is being made.

After this, method 200 moves to 216 to determine a requested data object (range of related memory addresses) from the requested memory address in the sampled memory request. In other words, method 200 determines a requested data object that is associated with the memory address in the memory access request.

For example, if the requested memory address in the sampled memory request falls within the range of memory addresses associated with a data object, then the data object is determined to be the requested data object. In an embodiment, the page number of the requested memory address can be used to identify the requested data object.

Method 200 next moves to 220 to record memory access information from the sampled memory request, such as the identity of the requesting NUMA node, the requested data object, the page number, and the identity of the storage NUMA node. The memory access information also includes timing and congestion data. Other relevant information can also be recorded.

Following this, method 200 moves to 222 to determine whether the size of the requested data object is a page or less, or more than a page. When the size of the requested data object is a page or less, method 200 moves to 224 to increment a count that measures the number of times that the requesting NUMA node has sought to access the requested data object, i.e., has generated a memory access request for a memory address in the range of the requested data object.

Next, method 200 moves to 226 to determine whether the count has exceeded a threshold within a predetermined time frame. When the count falls short of the threshold, method 200 returns to 214 to obtain another sample. When the count exceeds the threshold, method 200 moves to 230 to migrate the page that includes the requested data object to the requesting NUMA node. Alternately, a number of pages (tunable parameter) before and after the page that includes the requested data object can be migrated at the same time.

For example, if a data object stored in the local partition LP3 of a third NUMA node NN3 has a threshold of 1,000, the processors in a first NUMA node NN1 have accessed the data object in the local partition LP3 999 times, and the processors in a second NUMA node NN2 have accessed the data object in the local partition LP3 312 times, method 200 will migrate the page (alternately pages before and after) that includes the data object from the local partition LP3 to the local partition LP1 when the first NUMA node NN1 accesses the data object in the local partition LP3 for the 1,000th time within the predetermined time period.

Thus, one of the advantages of the present invention is that regardless of where small data objects are stored in the local partitions of the memory, the present invention continuously migrates the data objects to the hot local partitions, i.e., the local partitions of the NUMA nodes that are currently accessing the data objects the most.

For example, if a data object is stored in local partition LP1 because a processor in NUMA node NN1 is the first to access a memory address within the data object, but at a subsequent point during the execution of the program NUMA node NN2 extensively accesses the data object, then the present invention will migrate the data object from the local partition LP1 to the local partition LP2, thereby significantly reducing the time required for a processor in NUMA node NN2 to access the data object.

Referring again to FIG. 2, when the size of the requested data object is more than a page in 222, in other words when the requested data object is a multi-page requested data object, method 200 moves to 240 to determine how the page accesses are distributed, and record how the multi-page requested data object is accessed by the different NUMA nodes. In other words, method 200 determines which of the requesting NUMA nodes accessed the multi-page requested data object, the pages accessed, and the number of times that the requesting NUMA nodes sought to access the requested data object in a predefined time period. The distribution of the page accesses can be extracted based on a small fraction of samples.

For example, with reference to FIG. 1, if a multi-page data object is stored in local partition LP1 of NUMA node NN1, then method 200 could determine, as an example, that NUMA node NN2 accessed page three of the multi-page data object 1,000 times, and NUMA node NN3 accessed page four of the multi-page data object 312 times.

Following this, method 200 next moves to 242 to determine whether the multi-page requested data object is problematic. Problematic data objects include one location domain, multiple access domains, and remote accesses trigger congestion. If not problematic, method 200 returns to 214 to obtain another sample.

On the other hand, if the multi-page requested data object is determined to be problematic, such as by a page or more of the data object having exceeded a rebalance threshold, method 200 moves to 244 migrate selected one or more pages of the multi-page requested data object to balance/rebalance the multi-page requested data object. For multi-thread applications, each thread prefers to manipulate a block of the whole memory range of a data object.

For example, method 200 could determine that 1,000 page-three accesses by NUMA node NN2 exceeded the rebalance threshold and, in response, migrate page three from the local partition LP1 of NUMA node NN1 to the local partition LP2 of NUMA node NN2. On the other hand, nothing is migrated to the local partition LP3 because the 312 total accesses are less than the rebalance threshold. Thus, if any pages of the multi-page requested data object have exceeded a rebalance threshold, then method 200 moves to 244 to migrate the pages to the requesting NUMA nodes with the highest access rates.

Thus, another advantage of the present invention is that selected pages of a multi-page data object can be migrated to other NUMA nodes when the other NUMA nodes are extensively accessing the data object to balance/rebalance the data object and thereby substantially reduce the time it takes for the other NUMA nodes the access the information.

In some instances, a page of data from one local partition of the memory can be copied or replicated in another local partition of the memory. Replication can be detected in a number of ways. For example, a tool can be decompiled by first getting the assembly code from binary through decompiling tools (similar with objdump). Next, the functionality of the program is extracted from the assembly code. Then, the allocation and free functions are checked to determine whether they are exposing data objects.

As another example, page migration activities can be monitored via microbenchmarks to detect replication. Microbenchmarks can be run through a tool. Next, monitor system calls to migrate pages across data objects. If not, then migration happens within a data object, and it can be seen as semantic aware.

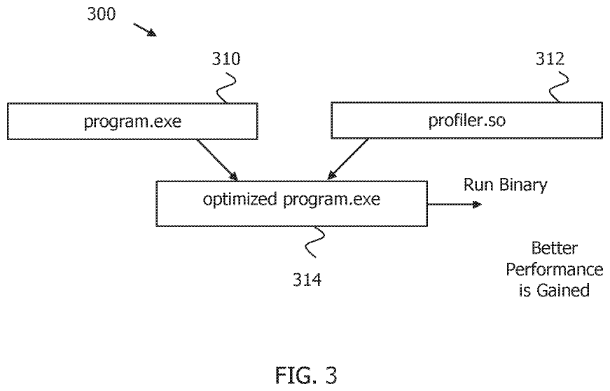

FIG. 3 shows a flow chart that illustrates an example of a method 300 that profiles a program in accordance with the present invention. As shown in FIG. 3, a program (program.exe) 310 is executed, and a profiler program (profiler.so) 312 is executed during a program run on a CPU or a similar functional processor to implement the present invention with respect to the program (program.exe) 310 to generate an optimized executable program (optimized program.exe) 314.

Thus, the present invention monitors which NUMA nodes are accessing which local partitions of the memory, and substantially reduces remote access latency times by migrating memory pages from the local partition of a remote NUMA node to the local partition of a hot NUMA node when the hot NUMA node is frequently accessing the local partition of the remote NUMA node, and balancing/rebalancing the memory pages.

One of the benefits of the present invention is that it provides pure user-space run-time analysis without any manual effort. The present invention also treats both large and small data well. In addition, the group migration of pages reduces the migration cost.

Comparing dynamic analysis to static analysis, a simulation based on static analysis incurs high runtime overhead. Measurement based on static analysis can provide insights with low overhead but still needs manual effort. Kernel based dynamic analysis required customized patches, which is cost prohibitive for commercial use. In addition, existing user space dynamic analysis treats large objects poorly.

Comparing semantic to non-semantic, page-level migration without semantic treats the program as a black box, and it may happen that some pages may move back and forth generating additional overhead. Semantic aware analysis, however, can migrate pages with less amount of time. A semantic aware analysis co-locates pages with data objects and computations.

The above embodiments are merely used for illustrating rather than limiting the technical solutions of the present invention. Although the present application is described in detail with reference to the foregoing embodiments, those of ordinary skill in the art should understand that the technical solutions recorded in the foregoing embodiments may still be modified or equivalent replacement may be made on part or all of the technical features therein. These modifications or replacements will not make the essence of the corresponding technical solutions be departed from the scope of the technical solutions in the embodiments of the present invention.

It should be understood that the above descriptions are examples of the present invention, and that various alternatives of the invention described herein may be employed in practicing the invention. Thus, it is intended that the following claims define the scope of the invention and that structures and methods within the scope of these claims and their equivalents be covered thereby.

What is claimed is:

1. A method of operating a NUMA system, the method comprising:
determining a requested data object from a requested memory address in a sampled memory request from a requesting NUMA node, the requested data object representing a range of memory addresses;
determining whether a size of the requested data object is a page or less, or more than a page; and
when the size of the requested data object is a page or less, incrementing a count that measures a number of times that the requesting NUMA node has sought to access the requested data object, determining whether the count has exceeded a threshold within a predetermined time period, and when the count exceeds the threshold, migrating the page that includes the requested data object to the requesting NUMA node.

2. The method of claim 1, wherein the requested data object is determined from the page number of the requested memory address.

3. The method of claim 1, further comprising sampling a memory request from the requesting NUMA node to generate the sampled memory request.

4. The method of claim 1, further comprising recording memory access information from the sampled memory request, the memory access information including an identity of the requesting NUMA node, the requested data object, the page number, and an identity of the storage NUMA node.

5. The method of claim 1, further comprising:
determining a number of data objects from the code of a program to be executed on the NUMA system; and
storing the data objects in the local partitions of a memory.

6. The method of claim 1, further comprising when the size of the requested data object is more than a page:
determining a distribution of page accesses; and
determining if the multi-page requested data object is problematic.

7. The method of claim 6, further comprising migrating one or more pages of the requested data object to another NUMA node when the requested data object is problematic.

8. A NUMA system comprising:
a memory partitioned into a series of local partitions;
a series of NUMA nodes coupled to the local partitions, each NUMA node having a corresponding local partition of the memory, and a number of processors coupled to the memory;
a bus that couples the NUMA nodes together; and
a profiler that is coupled to the bus, the profiler to:
determine a requested data object from a requested memory address in a sampled memory request from a requesting NUMA node, the requested data object representing a range of memory addresses;
determine whether a size of the requested data object is a page or less, or more than a page; and
when the size of the requested data object is a page or less, increment a count that measures a number of times that the requesting NUMA node has sought to access the requested data object, determine whether the count has exceeded a threshold within a predetermined time period, and when the count exceeds the threshold, migrate the page that includes the requested data object to the requesting NUMA node.

9. The NUMA system of claim 8 wherein the requested data object is determined from the page number of the requested memory address.

10. The NUMA system of claim 8 wherein the profiler to further sample a memory request from the requesting NUMA node to generate the sampled memory request.

11. The NUMA system of claim 8 wherein the profiler to further record memory access information from the sampled memory request, the memory access information including an identity of the requesting NUMA node, the requested data object, the page number, and an identity of the storage NUMA node.

12. The NUMA system of claim 8 wherein the profiler to further:
determine a number of data objects from the code of a program to be executed on the NUMA system; and
store the data objects in the local partitions of a memory.

13. The NUMA system of claim 8 wherein the profiler to further migrate one or more pages of the requested data object to another NUMA node when the requested data object is problematic.

14. A non-transitory computer-readable storage medium having embedded therein program instructions, which when executed by one or more processors of a device, causes the device to execute a process that operates a NUMA system, the process comprising:
determining a requested data object from a requested memory address in a sampled memory request from a requesting NUMA node, the requested data object representing a range of memory addresses;
determining whether a size of the requested data object is a page or less, or more than a page; and
when the size of the requested data object is a page or less, incrementing a count that measures a number of times that the requesting NUMA node has sought to access the requested data object, determining whether the count has exceeded a threshold within a predetermined time period, and when the count exceeds the threshold, migrating the page that includes the requested data object to the requesting NUMA node.

15. The medium of claim 14, wherein the requested data object is determined from the page number of the requested memory address.

16. The medium of claim 14, further comprising sampling a memory request from the requesting NUMA node to generate the sampled memory request.

17. The medium of claim 14, further comprising recording memory access information from the sampled memory request, the memory access information including an identity of the requesting NUMA node, the requested data object, the page number, and an identity of the storage NUMA node.

18. The medium of claim 14, further comprising:
determining a number of data objects from the code of a program to be executed on the NUMA system; and
storing the data objects in the local partitions of a memory.

19. The medium of claim 14, further comprising when the size of the requested data object is more than a page:
determining a distribution of page accesses; and
determining if the multi-page requested data object is problematic.

20. The medium of claim 19, further comprising migrating one or more pages of the requested data object to another NUMA node when the requested data object is problematic.
